(19) United States
(12) Patent Application Publication
(10) Pub. No.: US 2011/0158523 A1
(43) Pub. Date: Jun. 30, 2011

(54) IMAGE ENCODING APPARATUS, CONTROL METHOD, AND COMPUTER-READABLE MEDIUM

(75) Inventor: Naoto Yamada, Kawasaki-shi (JP)

(73) Assignee: CANON KABUSHIKI KAISHA, Tokyo (JP)

(21) Appl. No.: 12/949,884

(22) Filed: Nov. 19, 2010

(30) Foreign Application Priority Data
Dec. 25, 2009 (JP) 2009-296376

(51) Int. Cl. G06K 9/36

(52) U.S. Cl. 382/166

(57) ABSTRACT

An image encoding apparatus for encoding bitmap data for each block including a plurality of pixels, and the apparatus comprises: a pixel information holding unit which accumulates one of the number of pixels having a designated attribute among the pixels, and a value of the color information of the pixel data, and holds the result as accumulated information; a threshold setting unit which sets a threshold for each designated attribute of a pixel in the block; and an object determination unit which compares the accumulated information held in the pixel information holding unit with the threshold set for each attribute by the threshold setting unit, and determines whether to replace a value of each pixel in the block, based on the comparison result.

### BACKGROUND OF THE INVENTION

1. Field of the Invention

The present invention relates to an image encoding apparatus, control method, and computer-readable medium and, more particularly, to an image encoding technique.

2. Description of the Related Art

As a conventional encoding method, a method of processing image data for every plurality of blocks has been proposed in order to simplify processing hardware or facilitate parallel processing (see, for example, Japanese Patent Laid-Open No. 2008-301449). When performing processing for each block in Japanese Patent Laid-Open No. 2008-301449, lines of input image data of a block of interest are compared. In addition, whether a line matching a line of interest exists in already input lines is determined, and the matched line is replaced with specific identification information instead of pixel data, thereby increasing the encoding efficiency.

In this encoding processing performed for each block, however, if a given object is contained in only a portion of a block, the periodicity and continuity of a given region (in this case, a line) deteriorate, and the compression efficiency decreases. This is not limited to the method of Japanese Patent Laid-Open No. 2008-301449. That is, when performing an encoding method using data continuity, such as a runlength encoding method, for each block, the continuity similarly deteriorates, and the compression efficiency decreases.

### SUMMARY OF THE INVENTION

According to one aspect of the present invention, there is provided an image encoding apparatus for encoding bitmap data for each block including a plurality of pixels, wherein each of the pixels includes attribute data indicating an attribute of an object to which the pixel belongs and pixel data containing color information, and the apparatus comprising: a pixel information holding unit which accumulates one of the number of pixels having a designated attribute among the pixels, and a value of the color information of the pixel data, and holds the result as accumulated information; a threshold setting unit which sets a threshold for each designated attribute of a pixel in the block; an object determination unit which compares the accumulated information held in the pixel information holding unit with the threshold set for each attribute by the threshold setting unit, and determines whether to replace a value of each pixel in the block, based on the comparison result; and an encoding unit which, if all surrounding pixels not found to be replaced by the object determination unit, among surrounding pixels of a pixel of interest found to be replaced by the object determination unit, have the same value, replaces the value of the pixel of interest with the value of the surrounding pixels, thereby encoding the bitmap data of the block.

According to another aspect of the present invention, there is provided a method of controlling an image encoding apparatus for encoding bitmap data for each block including a plurality of pixels, wherein each of the pixels includes attribute data indicating an attribute of an object to which the pixel belongs and pixel data containing color information, and the method comprising: a pixel information holding step of causing a pixel information holding unit of the image encoding apparatus to accumulate one of the number of pixels having a designated attribute among the pixels, and a value of the color information of pixel data, and hold the result as accumulated information; a threshold setting step of causing a threshold setting unit of the image encoding apparatus to set a threshold for each designated attribute of a pixel in the block; an object determination step of causing an object determination unit of the image encoding apparatus to compare the accumulated information held in the pixel information holding step with the threshold set for each attribute in the threshold setting step, and determine whether to replace a value of each pixel in the block, based on the comparison result; and an encoding step of, if all surrounding pixels not found to be replaced by the object determination unit, among surrounding pixels of a pixel of interest found to be replaced by the object determination unit, have the same value, an encoding unit of the image encoding apparatus to replace a value of the pixel of interest with the value of the surrounding pixels, thereby encoding the bitmap data of the block.

Even if a block of interest contains only a portion of a predetermined attribute object when applying a method of encoding image data for each block, a pixel of interest is replaced with another pixel in accordance with the number of pixels of the object or the operation mode, as long as no visual effect occurs on the image quality, thereby efficiently encoding the data.

Further features of the present invention will become apparent from the following description of exemplary embodiments (with reference to the attached drawings).

### BRIEF DESCRIPTION OF THE DRAWINGS

FIG. 1 is a block diagram showing the overall configuration of an image processing system according to the present invention;

FIG. 2 is a block diagram showing software modules according to the present invention;

FIGS. 3A and 3B are views showing examples of data formats according to the present invention;

FIG. 4 is a block diagram showing the internal arrangement of an image compression unit according to the first embodiment;

FIGS. 5A, 5B, and 5C are views for explaining processing of a pixel calculation unit according to the first embodiment;

FIG. 6 is a view showing an encoded data format of an image compression encoding unit according to the first embodiment;

FIG. 7 is a block diagram showing the internal arrangement of a pixel compression unit according to the second embodiment;

FIG. 8 is a block diagram showing the internal arrangement of a piece determination unit according to the second embodiment;

FIG. 9 is a flowchart showing the procedure of an image encoding operation according to the second embodiment;

FIG. 10 is a flowchart showing the procedure of an image encoding operation according to the second embodiment;

FIGS. 11A and 11B are views showing examples of processing results in a threshold comparing unit according to the first embodiment; and

FIGS. 12A and 12B are views showing examples of processing results in a threshold comparing unit according to the second embodiment.

### DESCRIPTION OF THE EMBODIMENTS

The best mode for carrying out the present invention will be explained below with reference to the accompanying drawings.

### First Embodiment

### System Configuration

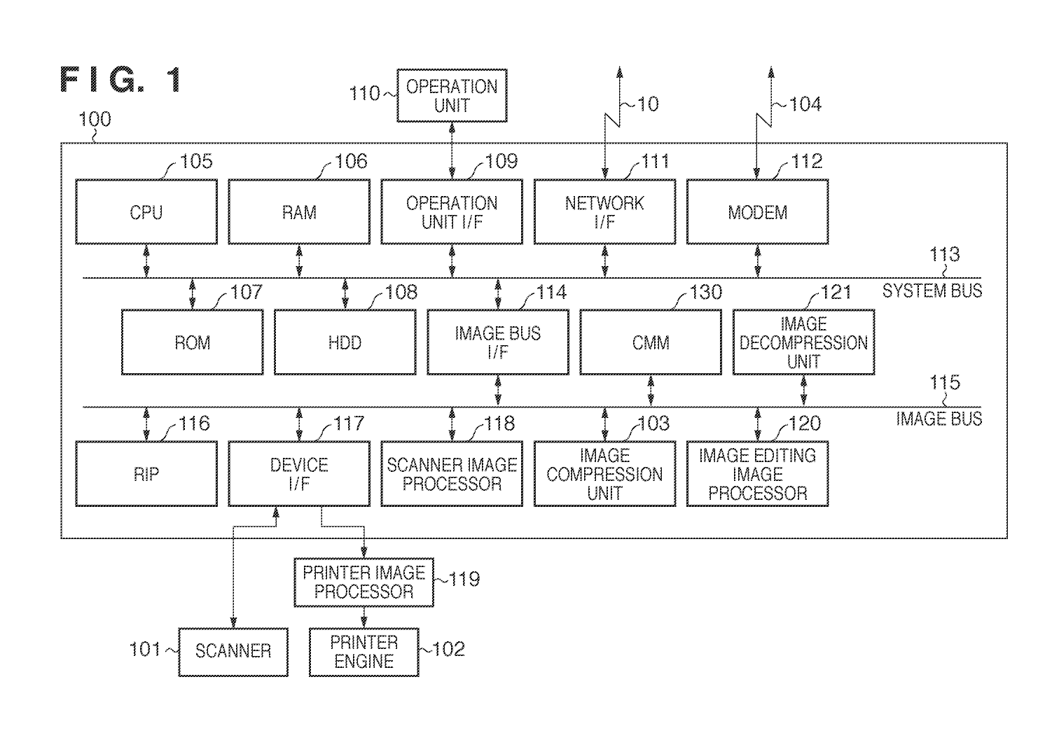

FIG. 1 is a block diagram showing the overall configuration of an image encoding apparatus according to this embodiment. Referring to FIG. 1, an image processing system 100 connects to a scanner 101 as an image input device, and to a printer engine 102 as an image output device via a printer image processor 119 in order to perform, on the printer side, image processing on data received and processed by the image processing system 100. The image processing system 100 performs control to read and print out image data. Also, the image processing system 100 is connected to a LAN 10 and public line 104, and performs control to receive and output image information and device information across the LAN 10.

A CPU 105 is a central processing unit for controlling the whole image encoding apparatus including the image processing system 100. A RAM 106 is a system work memory with which the CPU 105 operates, and is also an image memory for temporarily storing input image data. A ROM 107 is a boot ROM storing the boot program of the system. An HDD 108 is a hard disk drive, and stores system software for various kinds of processing, input image data, and the like. An operation unit I/F 109 is an interface unit for an operation unit 110 including a display screen capable of displaying image data and the like, and outputs operation display data to the operation unit 110. Also, the operation unit I/F 109 transfers information input from the operation unit 110 by an operator to the CPU 105. A network I/F 111 is implemented by, for example, a LAN card, and exchanges information with an external device by connection to the LAN 10. Furthermore, a modem 112 is connected to the public line 104, and exchanges information with an external device. The above-mentioned units are arranged on a system bus 113.

An image bus I/F 114 is an interface for connecting the system bus 113 and an image bus 115 for transferring image data at high speed, and is a bus bridge for converting the data structure. The image bus 115 is connected to a raster image processor (RIP) 116, device I/F 117, scanner image processor 118, image editing image processor 120, image compression unit 103, image decompression unit 121, and color management module (CMM) 130, each of which will be explained in detail below.

The RIP 116 rasterizes a page description language (PDL) code into image data. The device I/F 117 connects the scanner 101 and printer engine 102 to the image processing system 100 via the image decompression unit 121 and printer image processor 119, and performs image data synchronous-system/asynchronous-system conversion.

The scanner image processor 118 performs various processes such as correction, processing, and editing on input image data from the scanner 101. The image editing image processor 120 performs various kinds of image processing such as rotation, trimming, and masking of image data. When temporarily storing the image data processed by the RIP 116, scanner image processor 118, and image editing image processor 120 into the HDD 108, the image compression unit 103 encodes the image data by a predetermined compression method. When processing the compressed image data in the HDD 108 by the printer image processor 119 and outputting the data from the printer engine 102, the image decompression unit 121 decodes and decompresses the compressed encoded data. The printer image processor 119 performs processes such as image processing correction and resolution conversion corresponding to the printer engine, on the image data to be printed out. The CMM 130 is a dedicated hardware module for performing color conversion processing (also called color space conversion processing) on the image data, based on a profile or calibration data. The profile is information like a function for converting color image data expressed by a color space dependent on a device, into a color space (for example, Lab) independent of a device. The calibration data is data for correcting the color reproduction characteristics of the scanner 101 and printer engine 102.

[Software Configuration]

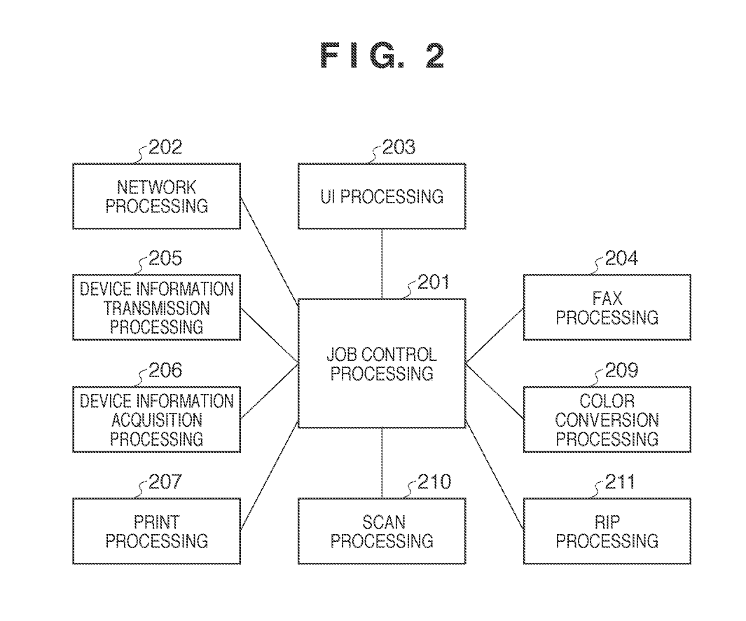

Each software module shown in FIG. 2 mainly operates on the CPU 105. Job control processing 201 shown in FIG. 2 comprehensively controls each software module, thereby controlling all jobs generated in an image formation apparatus (not shown), such as copying, printing, scanning, and FAX transmission/reception. Network processing 202 is a module for mainly controlling communication with an external device performed via the network I/F 111, and controls communication with each device on the LAN 10. When receiving a control command or data from a device on the LAN 10, the network processing 202 notifies the job control processing 201 of the contents. Also, based on instructions from the job control processing 201, the network processing 202 transmits a control command or data to a device on the LAN 10. UI processing 203 mainly controls the operation unit 110 and operation unit I/F 109. The UI processing 203 notifies the job control processing 201 of the contents of an operation performed by the operator via the operation unit 110, and controls the display contents on the display screen of the operation unit 110 based on instructions from the job control processing 201.

FAX processing 204 controls the FAX function. The FAX processing 204 performs FAX reception via the modem 112, performs image processing unique to FAX images, ad notifies the job control processing 201 of the received image. Also, the FAX processing 204 transmits an image designated by the job control processing 201 to a designated notification destination by FAX transmission. Print processing 207 controls the image editing image processor 120, printer image processor 119, and printer engine 102 based on instructions from the job control processing 201, thereby printing the designated image. The print processing 207 receives image data, image information (for example, the size, color mode, and resolution of the image data), layout information (for example, offset, enlargement/reduction, and pagination), and output sheet information (for example, the size and printing direction), from the job control processing 201. The print processing 207 then performs image processing on the image data by controlling the image compression unit 103, image decompression unit 121, image editing image processor 120, and printer image processor 119, and prints the image data on a designated sheet by controlling the printer engine 102.

Scan processing 210 controls the scanner 101 and scanner image processor 118 based on instructions from the job control processing 201, thereby reading an original on the scanner 101. The instructions from the job control processing 201 contain a color mode, and the scan processing 210 performs processing corresponding to the color mode. That is, the scan processing 210 inputs the original as a color image if the color mode is “color”, and inputs the original as a monochrome image if the color mode is “monochrome”. If the color mode is “auto”, the scan processing 210 determines whether the original is color or monochrome by prescan or the like, and inputs the image as an image based on the determination result by rescanning the original. The scan processing 210 scans an original on the original table of the scanner 101, and inputs the image as digital data. The scan processing 210 notifies the job control processing 201 of color information of the input image. In addition, the scan processing 210 performs image processing such as compression on the input image by controlling the scanner image processor 118, and notifies the job control processing 201 of the input image having undergone the image processing.

Color conversion processing 209 performs color conversion processing on a designated image based on instructions from the job control processing 201, and notifies the job control processing 201 of the image having undergone the color conversion processing. The job control processing 201 notifies the color conversion processing 209 of input color space information, output color space information, and an image as a target of color conversion. If the output color space notified to the color conversion processing 209 is a color space (for example, an Lab space) independent of an input device, input profile information as information for converting an input color space (for example, RGB) dependent on an input device into Lab is additionally notified. In this case, the color conversion processing 209 forms, from the input profile, a lookup table (LUT) for mapping from the input color space to the Lab space, and performs color conversion on the input image by using this LUT.

If the input color space notified to the color conversion processing 209 is the Lab space, output profile information for converting the Lab space into an output color space dependent on an output device is additionally notified. In this case, the color conversion processing 209 forms, from the output profile, an LUT for mapping from the Lab color space to the output color space, and performs color conversion on the input image by using this LUT. If both the input color space and output color space notified to the color conversion processing 209 are color spaces dependent on devices, both the input profile and output profile are notified. In this case, the color conversion processing 209 forms, from the input profile and output profile, an LUT for direct mapping from the input color space to the output color space, and performs color conversion on the input image by using this LUT. If the CMM 130 exists in the device, the color conversion processing 209 sets the generated LUT in the CMM 130, and performs color conversion by using the CMM 130. On the other hand, if the CMM 130 does not exist in the device, the CPU 105 performs the color conversion processing by using software.

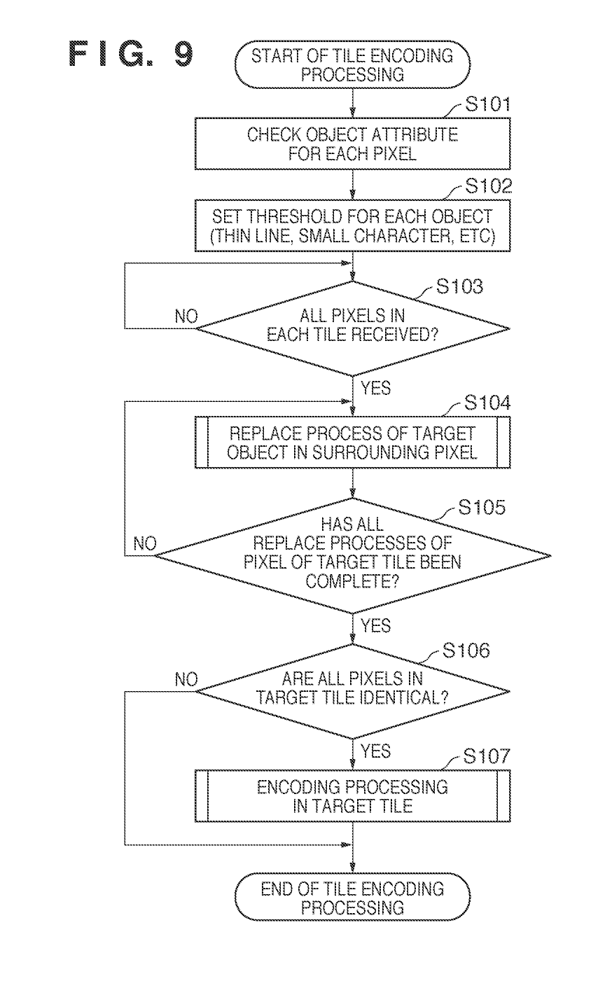

Based on instructions from the job control processing 201, RIP processing 211 interprets the PDL (Page Description Language), and performs rasterization into a bitmap image by rendering by controlling the RIP 116. This embodiment in an encoding operation while a printing operation is performed in the arrangement as described above will be explained in detail below with reference to a flowchart shown in FIG. 9. As described above, the PDL (Page Description Language) transmitted across the LAN 10 is received by the network I/F 111, and input from the image bus I/F 114 to the RIP 116. The RIP 116 interprets the transmitted PDL, converts the PDL into code data processable by the RIP 116, and executes rendering based on the code data.

[Data Format Examples]

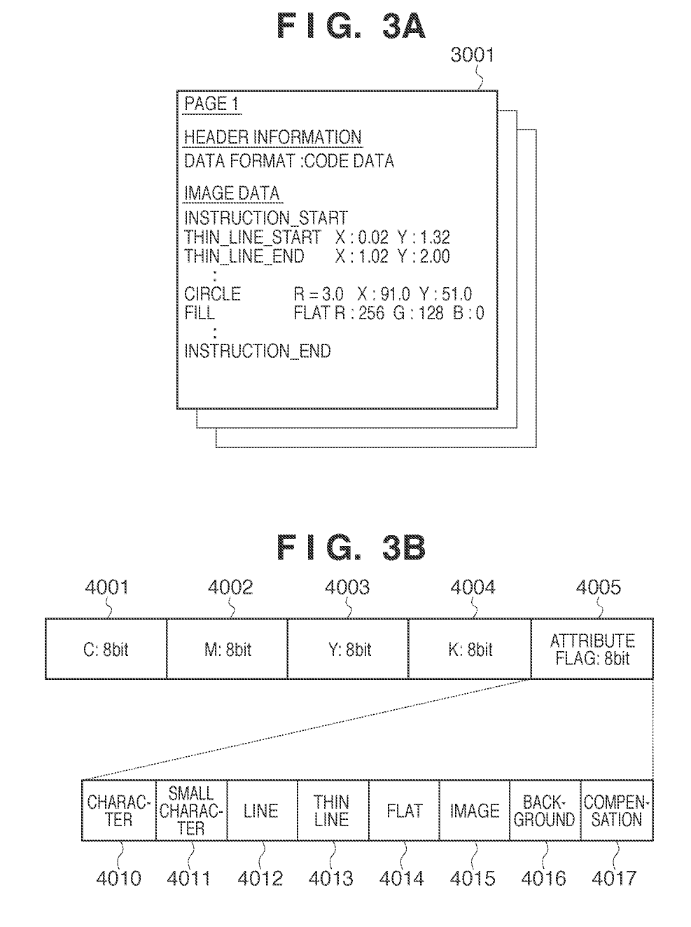

FIG. 3A shows an example of code data as a list containing objects in print data and instructions for rasterization in the RIP 116 described above. As shown in FIG. 3A, this code data describes drawing instructions, for example, figures such as line images and a circle, and colors corresponding to the figures. The RIP 116 executes rendering by receiving a drawing instruction such as THIN_LINE (thin line) in, for example, code data 3001, and forms bitmap data by outputting corresponding pixels. In this processing, before outputting the pixels drawn from, for example, the object THIN_LINE (thin line), an attribute flag (in this case, “thin line”) is added to each pixel so that the attribute of the object can be identified.

FIG. 3B shows a format example of pixel data in the bitmap data. In this example shown in FIG. 3B, each pixel is expressed by 256 gray levels of the CMYK system, that is, expressed by eight bits (regions 4001 to 4004). Furthermore, data of one pixel is obtained by adding eight bits (bits 4010 to 4017) of an attribute flag 4005, as attribute data indicating the attribute of an object, to a total of 32 bits of CMYK as color information. Note that in the attribute flag 4005, a character bit 4010, small character bit 4011, line bit 4012, thin line bit 4013, flat bit 4014, image bit 4015, and background bit 4016 are allocated in accordance with the characteristics of the object. In this embodiment, one bit of the attribute flag is allocated to a compensation bit 4017 as shown in FIG. 3B. That is, in an object such as a thin line, a compensation bit is added to a pixel of an intermediate line except for the start point and end point of the thin line. In pixel replacement processing (to be described later), therefore, even when a pixel except for the end portions of the thin line are to be replaced, this replacement is prohibited if the compensation bit is set. Since the compensation bit has the function of a prohibition bit against the replacement processing, it is possible to prevent the missing of important image information. Note that the data format is not limited to the format as shown in FIG. 3B, and the order and constituent elements can be changed in accordance with object characteristics other than those described above. The bitmap image data which is rendered and to which the attribute flag 4005 is added as described above is input to the image compression unit 103 via the image bus 115. Note that in this embodiment, data is sequentially output from the RIP 116 for each 32×32 tile (block).

[Image Compression Unit]

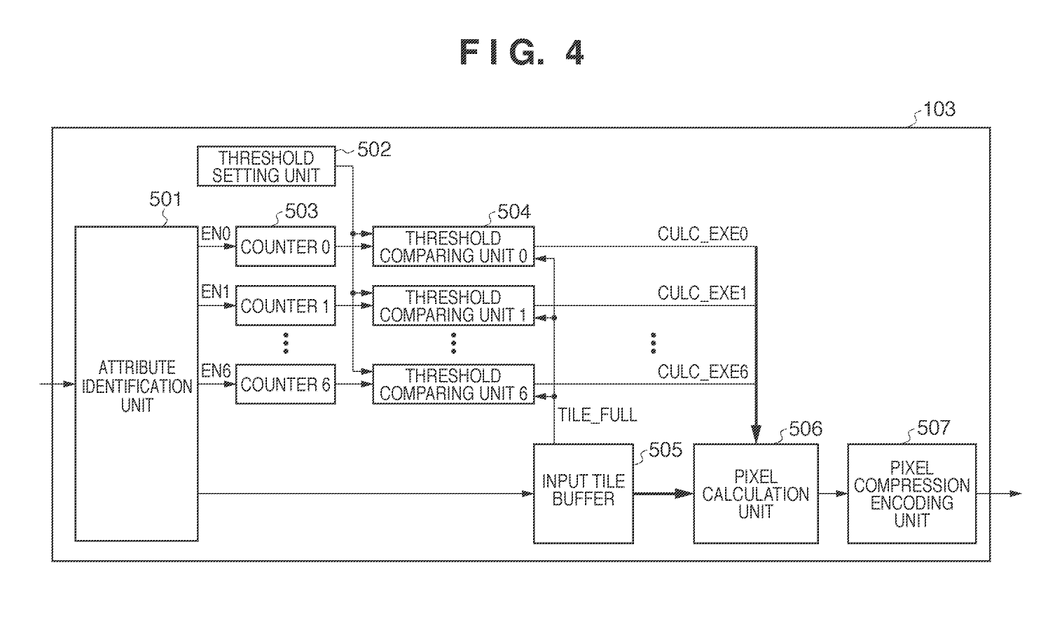

FIG. 4 is a detailed block diagram of the interior of the image compression unit 103. Each portion will be explained below with reference to the flowchart shown in FIG. 9. An attribute identification unit 501 identifies the object attribute flag 4005 added by the RIP 116 (S101). Consequently, when pixels of the target object are input, the attribute identification unit 501 issues count enable signals EN0 to EN6 based on the attribute flag 4005 (in this embodiment, seven types) contained in the image data, and increments corresponding counters 503 (0 to 6). The attribute identification unit 501 transmits the pixel data having the attribute flag 4005 to an input tile buffer 505 in the next stage. A threshold setting unit 502 can set an arbitrary value for each object attribute, and the print processing 207 sets a threshold corresponding to each attribute in the threshold setting unit 502 (S102). In this embodiment as described above, data is output from the RIP 116 for every 32×32=1024 pixels. Therefore, a set value of 0 to 1,024 can be set for each attribute (each of the attributes 4010 to 4016 in the attribute flag 4005 explained with reference to FIG. 3B). A pixel information holding unit is implemented by accumulated information with respect to each object held in the counter 503. As a consequence, the counter value corresponds to the number of pixels having a predetermined object attribute.

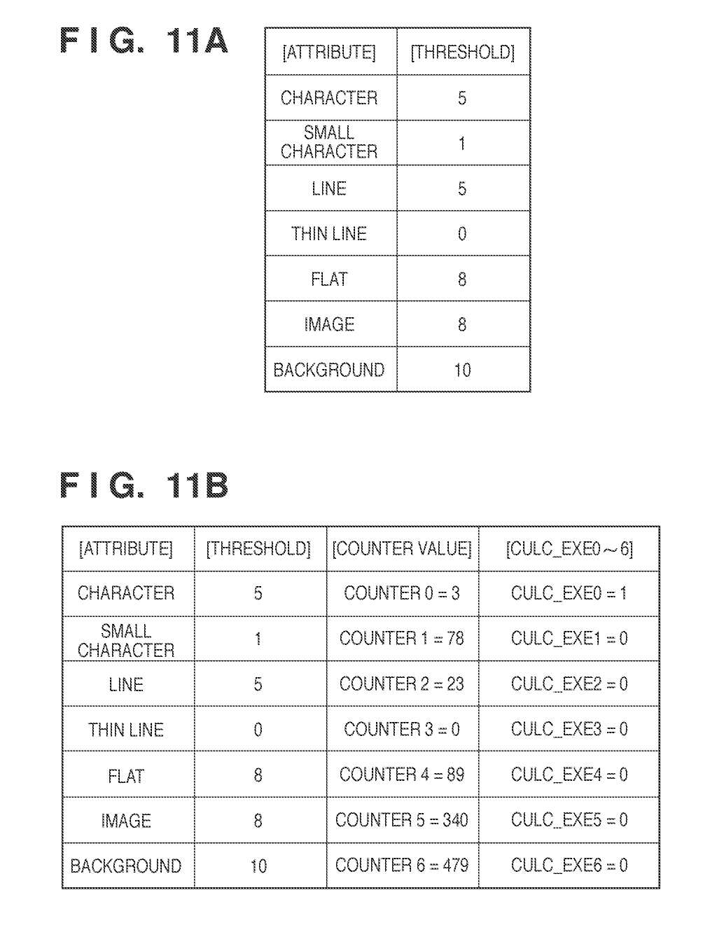

Note that a value to be set as each attribute value is set such that the threshold of an object with an attribute, such as “thin line” or “small character”, having a large influence on the image quality if pixel replacement is performed is set lower than those of other objects. Note also that the threshold of an object with an attribute such as “flat” to be used for, for example, painting of a figure is set higher than those of other objects. That is, it is possible to individually set attribute values as long as the image quality is unaffected. For example, when setting the threshold of each attribute in the threshold setting unit 502, a small value such as 0, 1, or 2 is set for an object, such as “thin line” or “small character”, having a large influence on the image quality if pixel replacement is performed, and a large value such as one of 5 to 10 is set for other objects. FIG. 11A shows examples of values set in this embodiment. When setting 0 as the threshold of an object such as “thin line”, the pixels of the object “thin line” are not practically replaced in the processing of a later stage. The threshold set by the threshold setting unit 502 can be set or changed in accordance with the printing mode of a printing operation performed by the image encoding apparatus.

Threshold comparing units 504 (0 to 6) receive a signal TILE_FULL issued from the input tile buffer 505 when the buffer of the input tile buffer 505 is filled up and all pixels of one tile have been received (S103). Then, each of the threshold comparing units 504 (0 to 6) compare the value of the threshold setting unit 502 with that of a corresponding one of the counters 503 (0 to 6), and issues a corresponding one of signals CULC_EXE0 to CULC_EXE6 if the threshold designated in the threshold setting unit 502 is larger. That is, an object with an attribute for which the signal CULC_EXE is issued has little influence on the image quality in the tile, so it is practically possible to replace the pixels with other pixels. FIG. 11B shows the results of the counters 503 (0 to 6) and the states of the signals CULC_EXE0 to CULC_EXE6, after pixels of one given tile are input for the set values of the attributes described previously. As shown in FIG. 11B, the signal CULC_EXE is issued when the counter value of an attribute is smaller than its threshold. In this example, CULC_EXE0=1 is issued because the counter value of the attribute “character” is smaller than its threshold. CULC_EXE=0 is issued for other attributes. This implements an object determination unit.

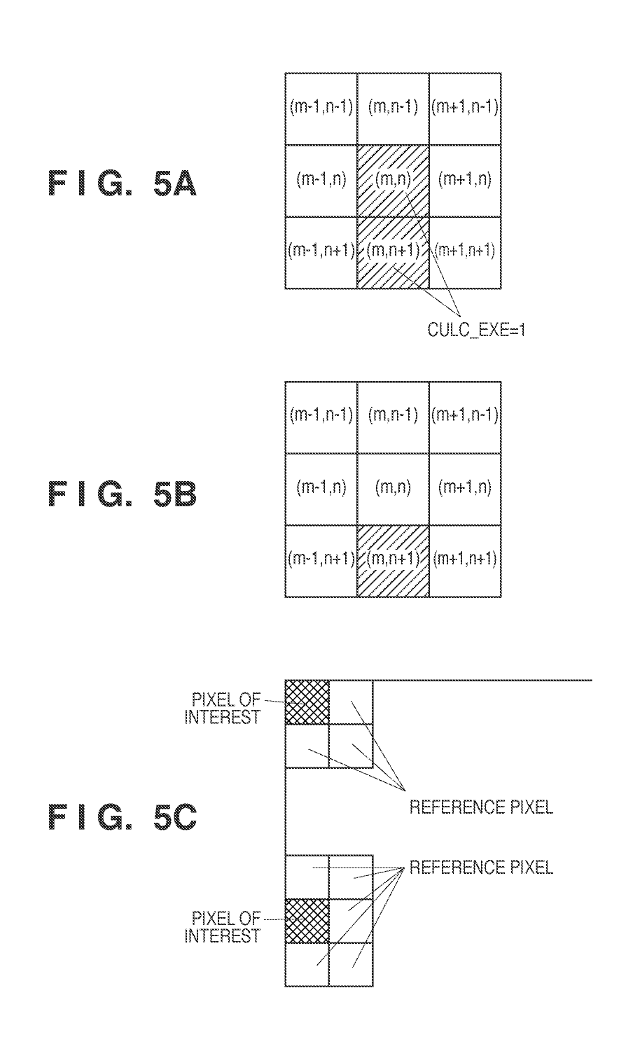

A pixel calculation unit 506 performs calculations on pixels read out from the input tile buffer based on the signals from the threshold comparing units 504 (0 to 6), and replaces the pixel information as needed (S104). FIGS. 5A, 5B, and 5C are views for explaining the calculation method.

[Replacement Calculation]

The tile data stored in the input tile buffer 505 as described above is sequentially output from the first pixel to the pixel calculation unit 506 immediately after the buffer is filled up. An operation when a pixel of interest at coordinates (m,n) is input to the pixel calculation unit 506 will be explained below. In this embodiment, calculation processing is performed in a 3×3 window including surrounding pixels of the pixel of interest, that is, eight surrounding pixels from the upper left pixel at coordinates (m−1,n−1) to the lower right pixel at coordinates (m+1,n+1) shown in FIG. 5A. This embodiment has an arrangement in which when the pixel of interest is input, the surrounding pixels (eight pixels) are simultaneously called and input. When the pixel of interest is input, the attribute flag of the pixel is checked, and the signals CULC_EXE output from the threshold comparing units 504 (0 to 6) are checked. If the signal CULC_EXE of the corresponding attribute is “1”, the eight surrounding pixels of the pixel of interest are analyzed. More specifically, among the surrounding pixels, only pixels for which no signal CULC_EXE has been issued, that is, only pixels (pixels other than halftone pixels in FIG. 5A) having information of unreplaceable attributes are compared as reference pixels. If all the pixels are identical pixels, the pixel of interest is replaced with the value of the identical pixels. In the case shown in FIG. 5A, the pixel of interest at the coordinates (m,n) is a pixel for which the signal CULC_EXE has been issued, and found to be replaceable. In addition, among the surrounding pixels, a halftone pixel at coordinates (m,n+1) is also a replaceable pixel (that is, a pixel having an attribute for which the signal CULC_EXE has been issued). In this case, seven other surrounding pixels are compared, and the pixel of interest is replaced, similarly to the seven surrounding pixels shown in FIG. 5B, if they are identical. When the pixel of interest exists at the end portion of the tile as shown in FIG. 5C (at the upper left corner or the left end of the tile in the case shown in FIG. 5C), the same processing as described above is performed by referring to only three surrounding pixels (when the pixel of interest exists at the upper left corner) or five surrounding pixels (when the pixel of interest exists at the left end) as shown in FIG. 5C. The pixels thus processed by the pixel calculation unit 506 are transmitted to a pixel compression encoding unit 507 in the next stage.

[Compression Encoding]

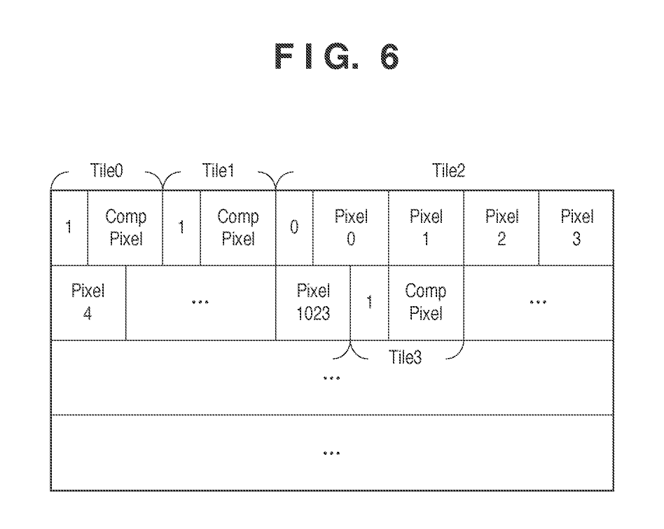

The pixels transmitted from the pixel calculation unit 506 are stored in an internal buffer (not shown) of the pixel compression encoding unit 507. When the pixels in all the tiles have been transmitted (S105), the pixel compression encoding unit 507 determines whether all the pixels in each tile are identical (S106). If all the pixel values in the tile are the same, the tile is compressed as one representative pixel having the pixel value as a representative pixel value. FIG. 6 shows examples of the streams of a plurality of encoded tile data. For example, when all pixels in a tile of interest are identical, the first bit of the stream of the tile data is allocated as a compression flag, and 1 is set in this compression flag when the tile is compressed into one representative pixel. Subsequently, an encoding operation is performed by storing data of one representative pixel (Comp Pixel in FIG. 6) as compressed data. If all pixels in the tile are not identical (Tile 2 in FIG. 6), 0 is set in the compression flag, and 1,024 pixels (Pixels 0 to 1023) equivalent to all the pixels of the 32×32 tile are stored. These processes are performed for each tile, and the tile encoding processing for the page is complete (S107).

From the image data encoded tile by tile by the image compression unit 103 as described above, the tiles of each page are stored in the HDD 108 via the image bus I/F 114. The stored tiles are called in synchronism with the output timing of the printer engine 102. The compressed encoded image data is decoded and decompressed by the image decompression unit 121 via the image bus I/F 114 and device I/F 121, thereby restoring the image data. The restored image data is temporarily rasterized page by page on the RAM 106. The rasterized image data is read out at the timing of a page to be printed by a tile dividing DMAC 300 in a printer image processor 119. The printer image processor 119 executes desired image processing of the printer system, and the printer engine 102 prints the image data on a printing medium and outputs the medium, thereby completing the printing operation.

As has been explained above, when encoding image data tile by tile, the attribute of an object existing in a tile and the number of pixels corresponding to the attribute are counted as in this embodiment. Consequently, replacement processing is performed on a pixel having little effect on the image quality and practically replaceable to another pixel, so it is possible to efficiently perform encoding. Also, even when a block of interest contains only a very small part of a predetermined attribute object, encoding can be performed efficiently by replacing object pixels in this very small portion with other pixels in accordance with the number of pixels or the operation mode, as long as there is no visual influence on the image quality.

### Second Embodiment

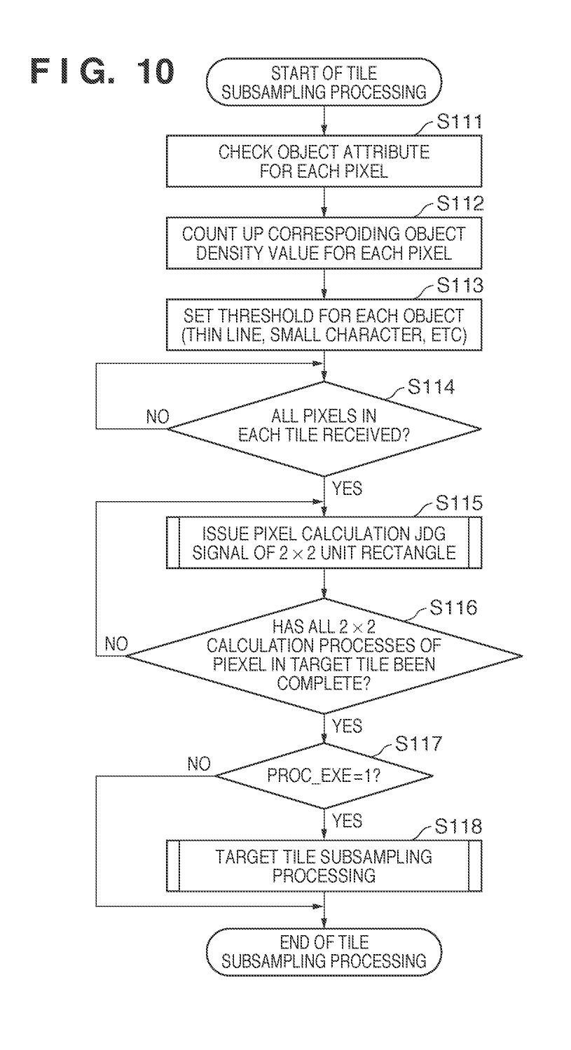

The overall configuration of an image processing system according to the second embodiment is the same as FIG. 1 explained in the first embodiment, and so an explanation of the configuration will be omitted. The second embodiment in an encoding operation during a printing operation will be explained in detail below with reference to a flowchart shown in FIG. 10.

Bitmap image data which is rendered by a RIP 116 and to which an attribute flag 4005 is added in the same manner as in the first embodiment is input to an image compression unit 103 via an image bus 115. One bit of the attribute flag 4005 is allocated to a compensation bit 4017 as shown in FIG. 3B explained in the first embodiment, in this embodiment as well. The compensation bit 4017 represents a pixel that is always processed as a reference pixel regardless of a signal CULC_EXE to be described in relation to a piece determination unit 806 in a later stage. The compensation bit 4017 is attached to a pixel of a character drawn on a black or dense object, or a pixel of an outline. This prohibits pixel replacement even when performing the replacement by, for example, density accumulation in a later stage. This prevents pixel replacement when, for example, a pixel is a white character having a low density but the influence is large if the pixel is replaced with an underlying object. Note that image data is sequentially output from the RIP 116 for each 32×32 tile, in this embodiment as well.

[Image Compression Unit]

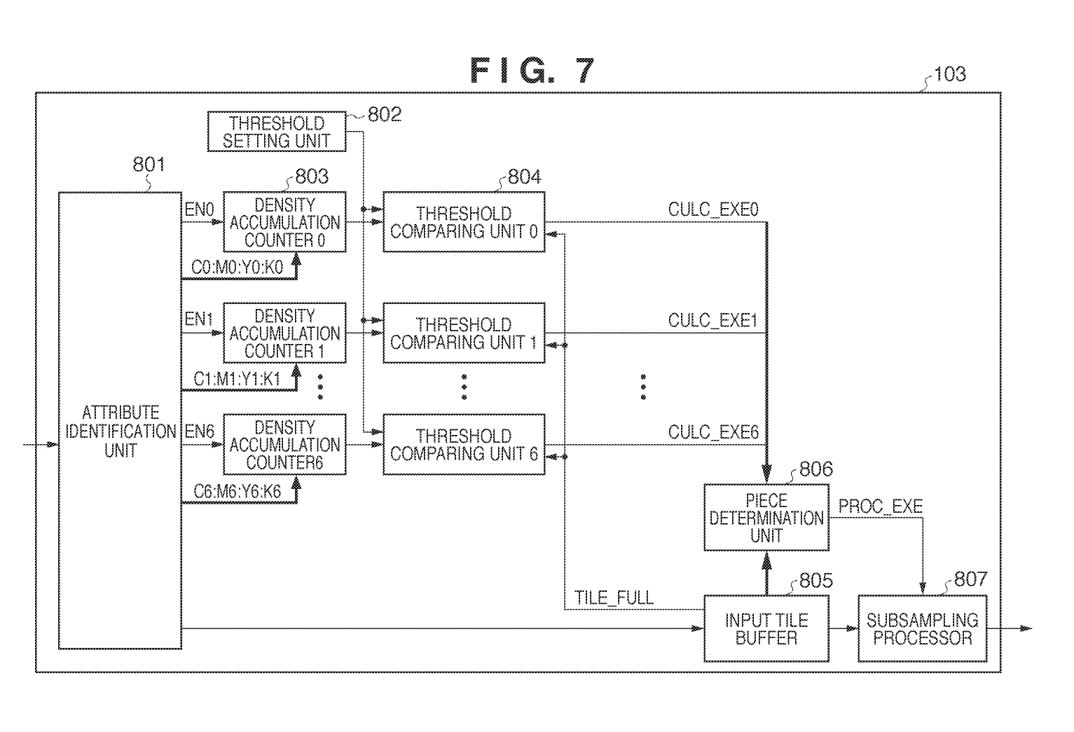

FIG. 7 is a detailed block diagram of the interior of the image compression unit 103 according to this embodiment. The image compression unit 103 will be described below in association with the processing shown in FIG. 10. An attribute identification unit 801 identifies an object attribute flag added by the RIP 116 (S111). When a pixel of a target object is input, the attribute identification unit 801 issues one of counter operation enable signals EN0 to EN6 based on the attribute flag 4005, and increments a corresponding one of density accumulation counters 803 (0 to 6) (S112). The density accumulation counters 803 have a counter for each color component of each pixel, and count the values of C:M:Y:K of each pixel. For example, when the density values of four components C, M, Y, and K are 0:64:128:255, the density accumulation counters 803 count up these values by the density. Accordingly, the density accumulation counters 803 sequentially count up the density of each pixel, and hold the accumulated density.

The pixel data having the attribute flag is also transmitted to an input tile buffer 805 in the next stage. A threshold setting unit 802 can set an arbitrary value for each component of the density accumulation counter 803 (0 to 6) installed for each object attribute, and print processing 207 sets a value corresponding to each attribute in the threshold setting unit 802 (S113). The image data output from the RIP 116 has 32×32=1024 pixels as described above, and the density value has 0 to 255 gray levels for each of the components C, M, Y, and K as explained with reference to FIG. 3B. Therefore, as the threshold setting range, 0 to 261,120 (1024 pixels×255) values can be set for each of the components C, M, Y, K with respect to each attribute (attributes 4005 to 4011 explained with reference to FIG. 3B).

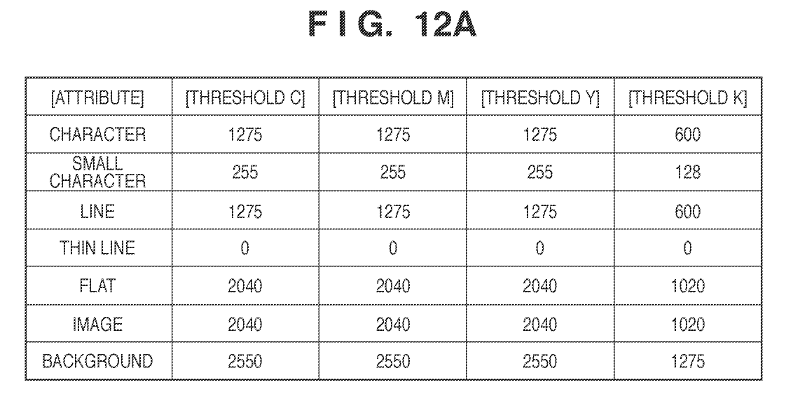

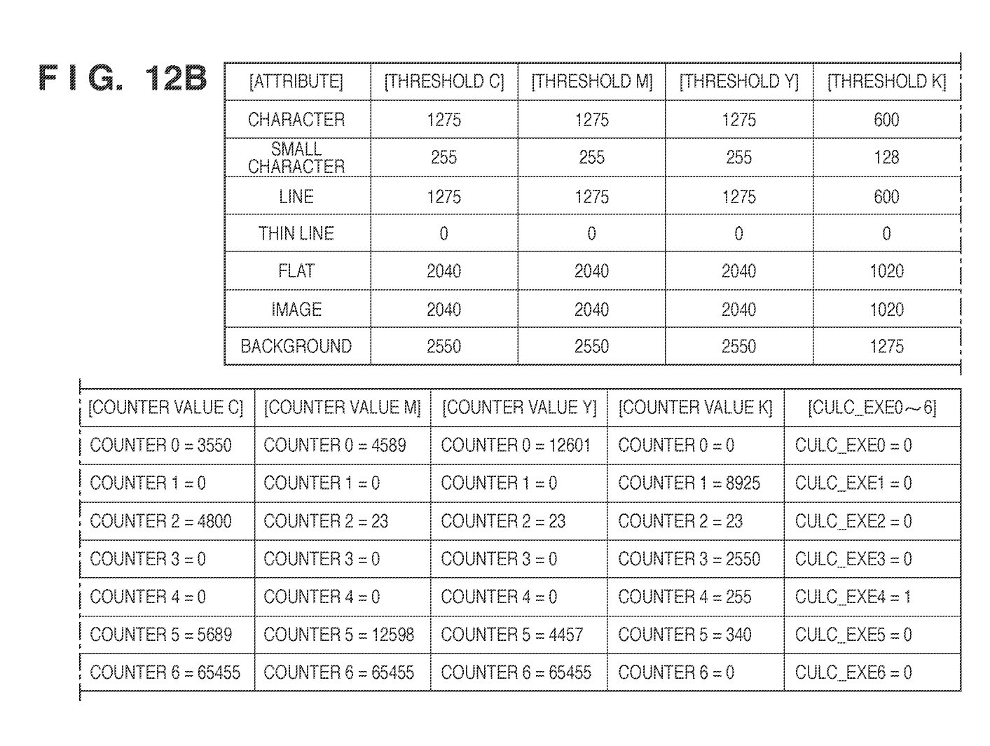

Note that as described previously in the first embodiment, a value to be set as each attribute value is set such that the threshold of an object with an attribute, such as “thin line” or “small character”, having a large influence on the image quality if pixel replacement is performed is set lower than those of other objects. Note also that the threshold of an object with an attribute such as “flat” to be used for, for example, painting of a figure is set higher than those of other objects. That is, it is possible to individually set attribute values as long as the image quality is unaffected. For example, when setting the threshold of each attribute in the threshold setting unit 802, a small value such as one of 0 to 510 is set for an object, such as “thin line” or “small character”, having a large influence on the image quality if pixel replacement is performed, and a large value such as one of 1,275 to 2,550 is set for other objects. FIG. 12A shows examples of values set in this embodiment. In this embodiment, the density threshold is set for each of the components C, M, Y, and K, and the density threshold of a component such as K having a visual effect is set smaller than those of other components as shown in FIG. 12A. That is, the thresholds can be set in more detail than in the first embodiment.

When setting 0 as the threshold of an object such as “thin line”, the pixels of the object “thin line” are not practically replaced in the processing of a later stage, as in the first embodiment.

Threshold comparing units 804 (0 to 6) receive a signal TILE_FULL issued from the input tile buffer 805 when the buffer of the input tile buffer 505 is filled up and all pixels of one tile have been received (S114). Then, the threshold comparing units 804 (0 to 6) compare the values of the individual components (in this embodiment, the four components C, M, Y, and K) of the threshold setting unit 802 and density accumulation counters 803 (0 to 6). If all the component values of the threshold setting unit 802 are larger than the density accumulation counters 803, the threshold comparing units 804 (0 to 6) issue signals CULC_EXE0 to CULC_EXE6. That is, an object with an attribute for which the signal CULC_EXE is issued has little influence on the image quality in the tile, so it is practically possible to replace the pixels with other pixels. FIG. 12B shows the results of the density accumulation counters 803 (0 to 6) and the states of the signals CULC_EXE0 to CULC_EXE6, after pixels of one given tile are input for the set values of the attributes described previously. The threshold of each component (C, M, Y, or K) of each attribute is compared with the counter value of the component, and a case in which the threshold is larger is obtained for each the components. Referring to FIG. 12B, CULC_EXE4=1 is issued for the attribute “flat”.

[Piece Determination Unit]

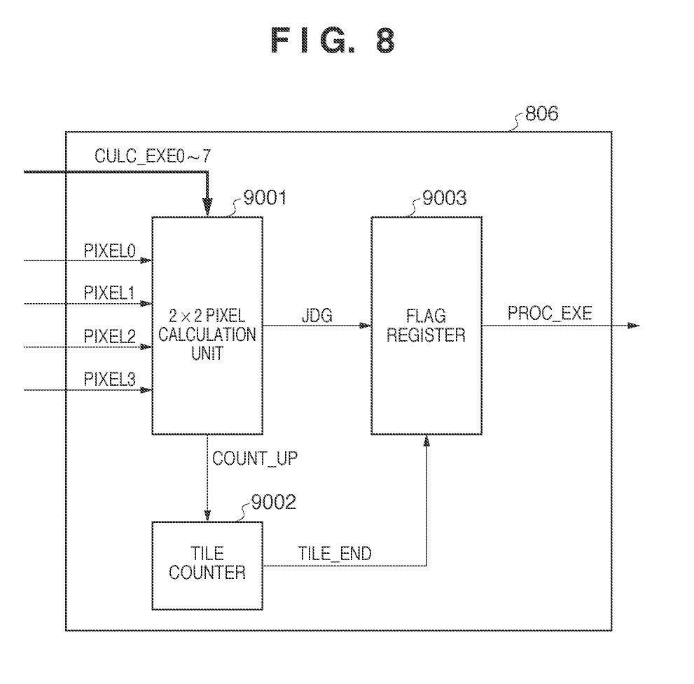

FIG. 8 is an internal block diagram of the piece determination unit 806. A 2×2 pixel calculation unit 9001 simultaneously reads out four pixels of a 2×2 unit rectangle from pixels input to the input tile buffer 805. Note that a unit of 2×2=4 pixels contained in a tile is called “a piece” for the sake of convenience. The 2×2 pixel calculation unit 9001 checks the states of the signals CULC_EXE0 to CULC_EXE6, performs calculations (to be described later), and transmits the determination results as a JDG signal to a flag register 9003 (S115). Also, a tile counter 9002 counts up by using, as a trigger, the reception of a signal COUNT_UP issued by the 2×2 pixel calculation unit 9001 whenever four pixels are input. When all pixels of the tile (in this embodiment, 32×32) are input to the 2×2 pixel calculation unit 9001, a signal TILE_END is input to the flag register 9003. The flag register 9003 can store, as an internal determination flag, the results sequentially input to and processed by the 2×2 pixel calculation unit 9001. The flag register 9003 checks the determination flag stored in accordance with the signal TILE_END input from the tile counter 9002, and outputs a signal PROC_EXE for determining whether to execute subsampling, to a subsampling processor 807 in the next stage.

The internal operation of the arrangement of the piece determination unit 806 described above will be explained below. First, as described previously, the 2×2 pixel calculation unit 9001 simultaneously reads out four pixels of each 2×2 unit rectangle from pixels input to the input tile buffer 805. Then, the 2×2 pixel calculation unit 9001 compares the pixel value of each pixel with its attribute. The 2×2 pixel calculation unit 9001 first checks the attribute, and then checks the signal CULC_EXE corresponding to the attribute. If the signal CULC_EXE of the corresponding attribute is “1”, the pixel is not regarded as a reference pixel. If the signal CULC_EXE of the corresponding attribute is “0”, the pixel is regarded as a reference pixel. In addition, as described previously, a pixel for which the compensation bit is “1” is a pixel found to have an effect on the image quality, so this pixel is regarded as a reference pixel regardless of the signal CULC_EXE. The 2×2 pixel calculation unit 9001 compares only the reference pixels thus determined. The 2×2 pixel calculation unit 9001 outputs “H” as the signal JDG if all the pixels have the same pixel value, and “L” as the signal JDG if the pixels do not have the same pixel value. In this way, the 2×2 pixel calculation unit 9001 performs calculations for each 2×2 unit rectangle. The flag register 9003 having received the signal JDG reflects the results on the internal determination flag. In this embodiment, “H” level is stored as an initial value in the determination flag, and the flag is changed to “L” level when “L” is input as the signal JDG. This determination flag maintains “L” level until all the determinations are complete. When calculations of all the pixels read out from the input tile buffer 805 are complete (in this case, a total of 256 calculations are performed because calculations are performed on 32×32=1024 for each 2×2 unit rectangle), the tile counter 9002 outputs the signal TILE_END to the flag register 9003. The flag register 9003 receives the signal TILE_END, and checks the determination flag. If the determination flag is “H” level, the flag register 9003 issues the signal PROC_EXE for enabling the execution of subsampling, to the subsampling processor (S116).

The subsampling processor 807 receives the signal PROC_EXE, and checks the state of the signal PROC_EXE (S117). If the signal PROC_EXE is issued (PROC_EXE=1), the subsampling processor 807 executes subsampling to a low resolution. That is, the subsampling processor 807 starts reading out pixels one by one from the input tile buffer, and sequentially outputs subsampled pixels. More specifically, the subsampling processor 807 executes subsampling processing of decreasing the original resolution by outputting one pixel from the 2×2 unit rectangle (S118).

From the image data subsampled tile by tile in the image compression unit 103 as has been explained above, the subsampled tiles of each page are stored in an HDD 108 via an image bus I/F 114. The stored subsampled tiles are called in synchronism with the output timing of a printer engine 102. The subsampled image data is decoded and decompressed by an image decompression unit 121 via the image bus I/F 114 and a device I/F 117, thereby restoring the image data. The restored image data is temporarily rasterized page by page on a RAM 106, as in the first embodiment. The rasterized image data is read out at the timing of a page to be printed by a tile dividing DMAC 300 in a printer image processor 119. The printer image processor 119 executes desired image processing of the printer system, and the printer engine 102 prints the image data on a printing medium and outputs the medium, thereby completing the printing operation.

As has been explained above, when subsampling image data tile by tile, the attribute of an object existing in a tile and the density of a pixel corresponding to the attribute are accumulated for each component. This makes it possible to perform the processing at a higher accuracy with less influence on the image quality. Also, subsampling can be performed efficiently by replacing a pixel practically replaceable with another pixel.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-296376, filed Dec. 25, 2009, which is hereby incorporated by reference herein in its entirety.

What is claimed is:

1. An image encoding apparatus for encoding bitmap data for each block including a plurality of pixels,
wherein each of the pixels includes attribute data indicating an attribute of an object to which the pixel belongs and pixel data containing color information, and
said apparatus comprising:
a pixel information holding unit which accumulates one of the number of pixels having a designated attribute among the pixels, and a value of the color information of the pixel data, and holds the result as accumulated information;
a threshold setting unit which sets a threshold for each designated attribute of a pixel in the block;
an object determination unit which compares the accumulated information held in said pixel information holding unit with the threshold set for each attribute by said threshold setting unit, and determines whether to replace a value of each pixel in the block, based on the comparison result; and
an encoding unit which, if all surrounding pixels not found to be replaced by said object determination unit, among surrounding pixels of a pixel of interest found to be replaced by said object determination unit, have the same value, replaces the value of the pixel of interest with the value of the surrounding pixels, thereby encoding the bitmap data of the block.

2. The apparatus according to claim 1, wherein said encoding unit further comprises a resolution conversion unit which performs subsampling from a resolution of the bitmap data of the block to an arbitrary resolution, thereby obtaining subsampled pixels as compressed data.

3. The apparatus according to claim 1, wherein said encoding unit further comprises a pixel compression unit which, if all pixels of the bitmap data of the block have the same pixel value, compresses the block by using the pixel value as a representative pixel value.

4. The apparatus according to claim 1, wherein the attribute data represents object attributes including a line, an image, and a character.

5. The apparatus according to claim 4, wherein said pixel information holding unit accumulates the number of pixels in the block for each object attribute based on the attribute data, and holds the result as the accumulated information.

6. The apparatus according to claim 4, wherein said pixel information holding unit accumulates a density value as the color information of the pixel data of pixels in the block for each object attribute based on the attribute data, and holds the result as the accumulated information.

7. The apparatus according to claim 4, wherein the attribute data includes a prohibition bit indicating that replacement of a value of the pixel is prohibited regardless of the determination result from said object determination unit.

8. The apparatus according to claim 1, wherein said threshold setting unit sets the threshold in accordance with a print mode by which a printing operation is performed.

9. A method of controlling an image encoding apparatus for encoding bitmap data for each block including a plurality of pixels,
wherein each of the pixels includes attribute data indicating an attribute of an object to which the pixel belongs and pixel data containing color information, and
said method comprising:
a pixel information holding step of causing a pixel information holding unit of the image encoding apparatus to accumulate one of the number of pixels having a designated attribute among the pixels, and a value of the color information of pixel data, and hold the result as accumulated information;
a threshold setting step of causing a threshold setting unit of the image encoding apparatus to set a threshold for each designated attribute of a pixel in the block;
an object determination step of causing an object determination unit of the image encoding apparatus to compare the accumulated information held in the pixel information holding step with the threshold set for each attribute in the threshold setting step, and determine whether to replace a value of each pixel in the block, based on the comparison result; and
an encoding step of, if all surrounding pixels not found to be replaced by the object determination unit, among surrounding pixels of a pixel of interest found to be replaced by the object determination unit, have the same value, an encoding unit of the image encoding apparatus to replace a value of the pixel of interest with the value of the surrounding pixels, thereby encoding the bitmap data of the block.

10. A computer-readable medium storing a program for causing a computer to function as:
a pixel information holding unit which accumulates one of the number of pixels having a designated attribute among pixels in a block including a plurality of pixels, and a value of color information of pixel data, and holds the result as accumulated information;
a threshold setting unit which sets a threshold for each designated attribute of a pixel in the block;
an object determination unit which compares the accumulated information held in said pixel information holding unit with the threshold set for each attribute by said threshold setting unit, and determines whether to replace a value of each pixel in the block, based on the comparison result; and
an encoding unit which, if all surrounding pixels not found to be replaced by said object determination unit, among surrounding pixels of a pixel of interest found to be replaced by said object determination unit, have the same value, replaces a value of the pixel of interest with the value of the surrounding pixels, thereby encoding bitmap data of the block.
